(19) United States
(12) Patent Application Publication
(10) Pub. No.: US 2005/0282939 A1
(43) Pub. Date: Dec. 22, 2005

(54) Storage-stable particle composition of polysaccharides and/or polysaccharide derivatives and at least one synthetic polymer, a process for production thereof and use thereof in construction material mixtures

(76) Inventors: Gunter Weber, Krefeld (DE); Meinolf Brackhagen, Walsrode (DE); Hartwig Schlesiger, Bad Fallingbostel (DE); Grit Siegmund, Bad Fallingbostel (DE); Arne Kull, Bomlitz (DE); Hans-Jurgen Juhl, Bad Fallingbostel (DE); Roland Bayer, Walsrode (DE); Erik-Andreas Klohr, Walsrode (DE)

Correspondence Address: BAYER MATERIAL SCIENCE LLC, 100 BAYER ROAD, PITTSBURGH, PA, 15205, US

(21) Appl. No.: 10/981,016

(22) Filed: Nov. 4, 2004

(30) Foreign Application Priority Data
Nov. 7, 2003 (DE) 10352081.3

(51) Int. Cl. C08K 5/15

(52) U.S. Cl. 524/35; 524/56

(57) ABSTRACT

A description is given of particle compositions of polysaccharides and/or polysaccharide derivatives and at least one synthetic polymer and if appropriate other aids, characterized in that I. the particles contain a plurality of solid phases, II. the solid phase of the synthetic polymer being contained in the solid phase of the polysaccharide and/or polysaccharide derivative. Likewise a description is given of a process for producing these particle compositions and also of their use in construction material mixtures, for example mortars, plasters, fillers or thin-bed adhesives.

### BACKGROUND OF THE INVENTION

1. Field of the Invention

The invention relates to storage-stable particle compositions of polysaccharides and/or polysaccharide derivatives and at least one synthetic polymer, a process for the production of storage-stable particle compositions and the use thereof in construction material mixtures.

2. Brief Description of the Prior Art

Polysaccharides and/or polysaccharide derivatives, in particular cellulose ethers, are used in many ways, for example, as thickener and water-retention agent, and also as protective colloid and film former. Fields of use are, for example, the production, of construction materials, paints and glues, cosmetic and pharmaceutical preparations (for example toothpastes), foods and drinks and as aids for polymerization processes [Römpp Lexikon Chemie [Römpp's chemistry lexicon]—Version 2.0, CD-ROM, Georg Thieme Verlag, Stuttgart/New York, 1999].

The production of cellulose ethers is known [Ulhmann's encyclopedia of industrial chemistry, Verlag Chemie, Weinheim/New York, (5.) A 5, 468-473].

As construction materials, polysaccharides and/or polysaccharide derivatives, in particular cellulose ethers, are frequently used, for example, as plasters, mortars, thin-bed adhesives and fillers, frequently together with synthetic polymers. The amounts of the synthetic polymer used are up to 25% by weight, based on the polysaccharide and/or the polysaccharide derivative. As is known in the art, the synthetic polymers in the construction material mixture affect various properties, for example, the processibility. Examples of such synthetic polymers are, for example, polyacrylamides mentioned in DE-A-100 13 577 and in

These synthetic polymers are present in the complete construction material mixture in markedly lower amounts than, a polysaccharide and/or polysaccharide derivative such as a cellulose ether, and can advantageously be added to the construction material mixture in a blend together with the polysaccharide and/or polysaccharide derivative. The synthetic polymers, in particular polyacrylamides and polyacrylamide derivatives, can, according to the prior art, be added in solid form to the polysaccharide and/or polysaccharide derivative, for example as described in DE A 3 913 518.

It is, however, difficult to achieve uniform distribution of the synthetic polymers or polymer mixtures in the entire construction material mixture, when they are added separately and in small amounts. More specifically, in amounts of approximately 0.01 to 25% by weight, based on the polysaccharide and/or polysaccharide derivative, the synthetic polymers or polymer mixture, owing to their low proportion in the construction material mixture, can only be added with considerable difficulty to the polysaccharide and/or polysaccharide derivative when the added separately.

Moreover, adding the synthetic polymers by mixing them with the polysaccharide and/or polysaccharide derivative, in particular cellulose ether, in powder form before addition to the construction material mixture has the following disadvantages:

If the polysaccharide and/or polysaccharide derivative and the synthetic polymer differ in particle size distribution or in density, during transport and storage, as well as handling, separation can occur, which can lead to an inhomogeneous distribution of the synthetic polymer.

Furthermore, under certain conditions, a decrease in the thickening activity of the synthetic polymers in the construction material mixture is observed. This effect occurs in particular in gypsum-bonded systems, if the storage time of the mixture is several months. Whereas the polysaccharide and/or polysaccharide derivative, for example a cellulose ether, retains its activity under the conditions prevailing in the construction material mixture, the synthetic polymer frequently loses its activity after some time, for example 6-12 months. This is presumably due to the action of moisture, as a result of which hydrolysable bonds in the synthetic polymer are cleaved. Also, due to its high pH and the presence of polyvalent ions in particular calcium and aluminium ions in the construction material mixture, chemical reactions or complexation reactions due to bases are also conceivable, which reactions could be responsible for the loss of activity of the synthetic polymers. Illustratively, the loss of activity of polyacrylamides and polyacrylamide derivatives in gypsum-containing construction material systems is promoted by moist-warm conditions, as occur, for instance, in long transport routes (marine transport) and in the warmer climatic zones. It is not known whether the loss of activity of these polymers is due to chain degradation, to hydrolysis of the amide bonds, to complexation of the polyacrylamide derivative by cations, or to other reasons. [Marcus J. Caulfield, Greg G. Qiao, and David H. Solomon; “Some Aspects of the Properties and Degradation of Polyacrylamides”; Chem. Rev. 2002, 102, 3067-3083, Shufu Peng, Chi Wu; “Light Scattering Study of the Formation and Structure of Partially Hydrolyzed Poly(acrylamide)/Calcium (II) Complexes”; Macromolecules 1999, 32, 585-589].

There is, therefore, a requirement for compositions of polysaccharides and/or polysaccharide derivatives and at least one synthetic polymer which do not have said disadvantages.

Attempts by the prior art to overcome these disadvantages are illustrated by DE-A-100 41 311 which discloses a process for adding additives to cellulose ethers according to which a methyl hydroxyethylcellulose is intensively kneaded with a redispersed poly(vinyl acetate)-ethylene copolymer for several hours. However, this process has the following disadvantages. The shear-sensitive starting material employed therein suffers considerable loss of viscosity owing to the kneading. The process is thus less economic than the conventional powder mixing. To obtain a cellulose ether having the same final viscosity as with a comparable powder mixture, a more expensive pulp must be used to compensate for the polymer chain breakdown of the cellulose ether.

Likewise, water-soluble or water-dispersible synthetic polymers containing groups which can be eliminated by hydrolysis cannot be stored in large amounts or over a relatively long period because of the limited storage stability in the presence of water.

Also, high-viscosity solutions or suspensions of polymers which, for example, have a viscosity of >1000 mPa.s, can only be produced and transported with great expenditure, and therefore can only be incorporated into the cellulose ether with considerable technical effort.

The object underlying the invention of DE-A-100 41 311 was to provide a storage-stable composition of polysaccharides and/or polysaccharide derivatives and at least one synthetic polymer that can be used in the most varied applications, for example in construction material mixtures.

According to the invention even though polymers can successfully be incorporated in a storage-stable manner into particle compositions, because of their slow-acting loss of activity, they could only be used in storage with restrictions.

The above-described disadvantages which accompany mixing of powders, can be avoided by adding the synthetic polymer, which is preferably used in solid form, to a water-moist polysaccharide and/or polysaccharide derivative, for example a cellulose ether, and subsequent homogenization, if appropriate with addition of water.

### SUMMARY OF THE INVENTION

The invention therefore relates to particle compositions comprising polysaccharides and/or polysaccharide derivatives and at least one synthetic polymer and also if appropriate other additives, characterized in that
A) the particles are formed of a plurality of solid phases,
B) the solid phase of the synthetic polymer being present in the solid phase of the polysaccharides and/or polysaccharide derivatives.

The solid phase of the polysaccharides and/or polysaccharide derivatives therefore contains the solid phase of the synthetic polymer, so advantageously that no separation phenomena are to be expected and also no unwanted losses of activity of the synthetic polymer are to be expected, for example due to action of further additives, oxygen or moisture.

Polysaccharides are taken to mean, for example, starch or cellulose, and polysaccharide derivatives are taken to mean that the polysaccharide is covalently bound to additional atomic groups. Examples of the derivatives are starch ethers, or cellulose ethers which is preferred. Cellulose ethers which are particularly preferred are cellulose ethers which are insoluble in boiling water, for example methyl hydroxyethylcellulose.

As a synthetic polymer, use is preferably made of compounds having hydrolysable groups, for example ester, amide, urethane groups.

Particularly preferably, use is made of polyacrylamides or polyacrylamide derivatives. For example, partially saponified polyacrylamides and copolymers of acrylamide and alkali metal acrylates having a mean molecular weight of about 1×10⁶ to 10×10⁶ g/mol can be used.

Customarily, the inventive particle composition comprises 0.01 to 25% by weight, preferably 0.1 to 10% by weight, particularly preferably 1 to 6% by weight, of the synthetic polymer, based on the dry polysaccharide or polysaccharide derivative.

The synthetic polymer is preferably admixed in the form of, for example, powder, flakes, grit or granules to the water-moist polysaccharide or polysaccharide derivative. The mixing is customarily carried out at temperatures below 100° C., in particular at temperatures below the flock point, if a polysaccharide and/or polysaccharide derivative having a thermal flock point in water is used. Suitable mixing aggregates can be operated continuously or batchwise

Preferably, the polysaccharide and/or polysaccharide derivative is present in the form of a water-moist filter cake. In principle, however, polysaccharides and/or polysaccharide derivatives admixed with other solvents and solvent mixtures can be used, for example cellulose ethers, purified with organic solvents or solvent mixtures. For example, a hydroxyethylcellulose purified using a mixture of ethyl alcohol and water can also be used.

If a cellulose ether having a thermal flock point in water is used, advantageously a water-moist filter cake is employed. The water content of the polysaccharide and/or polysaccharide derivative before addition of the synthetic polymer should be 30-80% by weight, preferably between 50 and 70% by weight. To this must be added water, if appropriate after the filtration.

The mixture of polysaccharide and/or polysaccharide derivative and synthetic polymer is fed, after mixing, to a homogenizer and if appropriate, before or during homogenization, admixed with water. Suitable homogenizeres are specified in DE-A-100 09 411 on page 4, lines 26 to 54. Preference is given to continuous apparatuses in which the composition is homogenized. Particular preference is given to apparatuses known under the term screw press or extrusion press, and also screw pumps. In many cases it is sufficient to homogenize the mixture in a 1- or 2-shaft screw which is furnished at the end with an orifice plate (for example a meat mincer).

It is not critical whether the apparatus is operated continuously or batchwise. If appropriate, before, after or during this process step, other synthetic polymers, aids or modifiers can be added in amounts of up to 50% by weight, but preferably in lesser amounts of about up to 10%, based on the total mass.

During the homogenization, up to 2, preferably up to 1.5, particularly preferably 1-1.5 parts by weight of water are added per part by weight of composition of polysaccharide and/or polysaccharide derivative and synthetic polymer.

The resulting mass produced in this manner is dried and ground. Preferably, the product is subjected to mill drying. The mass of polysaccharide and/or polysaccharide derivative and synthetic polymer produced generally does not have a free-flowing consistency under its own weight. However, the mass should be sufficiently plastic that it can be deformed by hand.

Which consistency is the most advantageous within the specified bandwidth depends greatly on the cellulose ether and the synthetic polymer and also on the water content and the grinding process. The best setting in each case must be determined by experiments.

For example, in the case of the use of cellulose ethers having a thermal flock point in water and subsequent grinding in a screenless high-speed gas-stream impact mill, for example as described in DE-A-100 09 409, a water content of the homogenized mass of 50-80% by weight, preferably 65-78% by weight, based on the total mixture, is set. The water content, however, can vary as a finction of the amount and composition of the synthetic polymer and must be determined by suitable experiments for each particle composition of polysaccharides and/or polysaccharide derivatives having a synthetic polymer.

If appropriate, after grinding further additives in solid and/or liquid form can be added to the inventive composition.

In the case of the particle composition which is obtained after grinding and comprises at least one polysaccharide and/or polysaccharide derivative and a synthetic polymer, the synthetic polymer is distributed in the polysaccharide and/or polysaccharide derivative and protected by this means from environmental influences, for example moisture, an elevated pH in a construction material mixture, or oxygen.

A further advantage of the inventive particle composition is the avoidance of uneven concentration and portioning of the synthetic polymer in the construction material mixture. This avoids inhomogeneities forming in the finished product, as can occur in the case of powder compounding. Furthermore, this dispenses with the storage of synthetic polymers in various finenesses. Separation phenomena during storage and handling of the particle composition are not to be expected.

The invention further relates to a process for producing the above-described particle composition, in which
A) to a water-moist polysaccharide or polysaccharide derivative, preferably having a water content of 30-80% by weight, one or more water-soluble or water-dispersible synthetic polymers, in a total amount of 0.01 to 25% by weight, based on the dry cellulose ether, in non-dissolved form and, if appropriate, other aids are added and
B) this mixture is processed in a homogenizer, which preferably works continuously, to form a mass, if appropriate water being added in this process stage, and
C) the resultant mass is ground and dried or first dried and then ground or subjected to mill drying.

The storage and transport of solutions, suspensions or dispersions of the polymers can be dispensed with in this process. This process, because of the short contact time with water, is particularly suitable for water-soluble or water-dispersible synthetic polymers. Also, this process is particularly advantageous for incorporating water-soluble or water-dispersible synthetic polymers which contain hydrolysable bonds, for example polyacrylamides and polyacrylamide derivatives.

The invention further relates to the use of the abovementioned particle compositions as thickener in construction material mixtures, for example plasters, fillers, thin-bed adhesives and mortar mixtures.

The invention is further illustrated but is not intended to be limited by the following examples in which all parts and percentages are by weight unless otherwise specified.

### EXAMPLES

The values for DS_{methyl} and MS_{hydroxyethyl} were determined by the Zeisel method.

Definitions of DS_{methyl} and MS_{hydroxyethyl} are known in the art.

The viscosity measurements reported were carried out using a Haake RV 100 rotary viscometer, system M500, measuring device MV, at a shear rate of 2.55 s⁻¹. Unless stated otherwise, the solutions comprise 2% by weight of cellulose ether in water.

Percentages are percentages by weight, unless stated otherwise.

To determine the sieving curves, the cellulose ethers were screened using a DIN 4188 sieving machine.

### Example 1

In a commercially conventional horizontal-shaft mixer (from Drais) a water-moist MHEC (35 kg; DS_{methyl} 1.86; MS_{hydroxyethyl} 0.27; water content 56% by weight) were admixed with acrylamide-acrylate copolymer (0.92 kg; polyacrylamide A; acrylate content 20-40 mol %). Then water is added, with mixing, to a water content of 72-73%.

The resultant mass is introduced into a stirred vessel having a vertical mixer shaft. The agitator blades of the mixer shaft are arranged in such a manner that a pressing action is achieved in the direction of the discharge screw furnished with an orifice screen which is mounted on the vessel bottom. The vessel wall is provided with flow spoilers to prevent the mass from turning in conjunction. The material for grinding is pressed through the orifice screen and collected and homogenized and charged again into the stirred vessel.

The material for grinding is then transported from the stirred vessel via the discharge screw into a commercially conventional high-speed gas-stream impact mill and dried by heated gas mixture simultaneously with the grinding. The product is separated via a cyclone downstream of the mill and is collected after removal of the coarse fraction >315 μm by means of a gyratory riddle.

The same water-moist MHEC, for comparison purposes, is moistened without addition of polyacrylamide to a water content of 72-73% and ground and dried like the inventive composition.

| | Comparison 1 | Particle composition 1 |
|---|---|---|
| Water content in % by weight | 3.5 | 2.7 |
| Viscosity in mPa s | 35380 | 37330 |
| Polyacrylamide A | — | 6% by weight |
| Bulk density in g/l | 290 | 270 |
| Fraction < 250 μm | 89% by weight | 91% by weight |
| Fraction < 63 μm | 26% by weight | 32% by weight |

¹Drying loss after 4 h at 105° C.

### Example 2

A water-moist MHEC (48 kg; DS_{methyl} 1.55; MS_{hydroxyethyl} 0.27) is, as described in Example 1, admixed with polyacrylamide A (0.93 kg). The water content after addition of polyacrylamide A, based on the total drying mass, was 70% by weight. In a further experimental setup, an acrylamide-acrylate copolymer having an acrylate content of approximately 5-10 mol % (pqlyacrylamide B) is used. Subsequently, the mass, as described in Example 1, is charged into the stirred vessel, homogenized and ground.

The same water-moist MHEC, for comparison purposes, is moistened without addition of a synthetic polymer to a water content of 70% by weight, and ground and dried like the inventive composition.

| | | Particle | Particle |
|---|---|---|---|
| | Comparison 2 | composition 2 | composition 3 |
| Water content in % by | 6.7 | 4.4 | 5.6 |
| weight | | | |
| Viscosity in mPa s | 57750 | 60280 | 55760 |
| Polyacrylamide A | — | 4.8 | — |
| Polyacrylamide B | — | — | 4.8 |
| Bulk density in g/l | 280 | 230 | 220 |
| Fraction < 250 μm | 85 | 86 | 86 |
| Fraction < 63 μm | 18 | 26 | 22 |

One kilogram each of a homogenized gel of the particle compositions of the inventive Examples 2 and 3 are taken off from the stirred vessel before grinding, dried in a circulated air drying cabinet at 55° C. and ground in a laboratory screen-type mill (from Alpine) provided with a 0.5 mm screen.

| | Particle | Particle |
|---|---|---|
| | composition 4 | composition 5 |
| Water content in % by weight | <10 | <10 |
| Polyacrylamide A | 4.8 | — |
| Polyacrylamide B | — | 4.8 |
| Bulk density in g/l | 360 | 430 |
| Fraction < 250 μm | 64 | 68 |
| Fraction < 63 μm | 19 | 14 |

### Example 3

A water-moist MHEC (DS_{methyl} 1.55; MS_{hydroxyethyl} 0.26; water content 58% by weight) mixed with 4.8% by weight of polyacrylamide B is continuously conveyed into a twin screw. The product stream is set to 18-20 kg/h. The twin screw has a screw diameter of 60 mm and a length of 1200 mm. 8-9 l/h of water are added through a borehole in the shell of the screw.

The mixture thus produced passes through a perforated plate having boreholes of diameter approximately 1 cm and is conveyed into a single screw. This screw, via a further orifice screen, feeds a commercially conventional screenless high-velocity gas-stream impact mill in which the product is dried by means of a heated gas mixture simultaneously with the grinding.

In a further experiment, the procedure as described above is followed, with the difference that polyacrylamide A is used and 5 l/h of water are metered.

In a comparative example no polyacrylamide is used.

| | | Particle | Particle |
|---|---|---|---|
| | Comparison 3 | composition 6 | composition 7 |
| Water content in % by | 3.3 | 3.0 | 3.6 |
| weight | | | |
| Viscosity² in mPa s | 55110 | 51940 | 50810 |
| Polyacrylamide A | — | — | 4.8 |
| Polyacrylamide B | — | 4.8 | — |
| Bulk density in g/l | 180 | 170 | 180 |
| Fraction < 250 μm | 95 | 97 | 98 |
| Fraction < 63 μm | 27 | 36 | 51 |

### Example 4

The water-moist MHEC from the preceding example (DS_{methyl} 1.55; MS_{hydroxyethyl} 0.26; water content 59.4% by weight) is admixed with 10% by weight of polyacrylamide A, based on dry MHEC, in a laboratory kneader from Werner & Pfleiderer, type UK 4-III 1 equipped with Z blades. The mass is then moistened to a water content of 70.5% by weight and kneaded for 60 min. The product is dried in a circulate-air drying cabinet at 55° C. and ground in a laboratory screen mill (from Alpine) equipped with a 0.5 mm screen.

| | Particle |
|---|---|
| | composition 8 |
| Water content in % by weight | 2.1 |
| Polyacrylamide A | 10 |
| Polyacrylamide B | — |
| Fraction < 250 μm | 76 |
| Fraction < 63 μm | 29 |

### Example 5

### Process Comparison

According to the Invention:

A water-moist MHEC (DS_{methyl} 1.57; MS_{hydroxyethyl} 0.25; water content 63% by weight) is conveyed continuously into a twin screw. The product stream is set to 18-20 kg/h. The twin screw has a screw diameter of 60 mm and a length of 1200 mm. Approximately 14 kg/h of water are added through a borehole in the screw shell.

The mixture thus produced passes through a perforated plate having boreholes of diameter approximately 1 cm and is conveyed into a single screw. This screw, via a further orifice plate, feeds a commercially conventional screenless high-velocity gas-stream impact mill in which the product is dried by means of a heated gas mixture simultaneously with the grinding.

Comparison with the Prior Art:

In a further comparative example, polyacrylamide A dissolved in water is added to the MHEC. 15 kg/h of a 15% strength by weight viscose solution of the polyacrylamide A in water are added through a borehole in the screw shell. For this it is necessary to use a gearwheel pump. Grinding was not possible because of severe flow variations in the mill. The mass produced was visibly inhomogeneous and consisted of dissolved polyacrylamide and virtually unchanged cellulose ether.

### Example 6

In a comparative experiment, the non-kneaded water-moist MHEC starting material from the preceding example was processed without addition of polyacrylamide. For this, the starting material, without further processing, was dried directly in a circulated-air drying cabinet at 55° C. and ground in a laboratory screen mill (from Alpine) equipped with a 0.5 mm screen.

A further sample of the starting material was moistened to a water content of 70.5% by weight and kneaded for 60 min in a laboratory kneader as described above. The sample was then dried and ground as in the preceding example.

The viscosity of the product produced by kneading is markedly reduced compared with non-kneaded starting material dried and ground in the same manner. The same effect is observed when the polyacrylamide A is kneaded.

| | | Non- | | Change, |
|---|---|---|---|---|
| | | kneaded | Kneaded | % |
| Comparison 4 | Viscosity in mPa · s | 59300 | 45330 | −23.5 |
| | (2% by weight solution) | | | |
| MHEC | Viscosity in mPa · s | 8032 | 5710 | −28.9 |
| | (1% by weight solution) | | | |
| Comparison 5 | Viscosity in mPa · s | 20000 | 18070 | −9.7 |
| | (2% by weight solution) | | | |
| Polyacryl- | Viscosity in mPa · s | 6753 | 5719 | −15.3 |
| amide A | (1% by weight solution) | | | |

Storage Stability Test

The methyl hydroxyethylcellulose (comparison 1) described in Example 1 was mixed dry intensively with 4.6% by weight of polyacrylamide A which was used in Example 1 (comparative mixture 1).

These mixtures were compared with the inventive particle composition 1. The service testing of the mixtures and of the inventive particle composition with respect to their storage stability was performed in a gypsum filler system simulating one in service.

For this, the inventive particle composition 1 or the comparison mixture 1 (0.5% by weight) were admixed dry to the ready-to-use gypsum mixture. To test the storage stability, one portion of the dry mixtures of gypsum filler base mixture and additive was stored for a period of 10 days sealed airtightly in polyethylene bags at 40° C. in a drying cabinet and another portion was stored as reference material in a standard climate as specified in DIN EN 1204 in polyethylene bags which were not sealed air-tightly.

The gypsum filler material was evaluated in a hand stirring test, in which the thickening behaviour and stability of the stirred gypsum filler were evaluated. For this the dry material was admixed with the corresponding amount of make-up water (water/solids factor 0.58) and stirred by hand (stirring time 60 s), with the first evaluation of the filler material being performed. After a resting time of 10 min, the gypsum filler was stirred again and again evaluated. Criteria for the evaluation were thickening behaviour and stability of the gypsum filler. The reference materials from the standard storage were rated in each case at 100% with respect to thickening behaviour and stability, correspondingly, reduced thickening and stability of the heat-stored samples were assessed with scores less than 100%. The complete loss of thickening action of the polyacrylamide resulted in a value of 80%.

Tables 1 and 2 illustrate the surprisingly increased storage stability with the use of the inventive particle composition even under critical storage conditions under which a marked loss of activity is to be found for conventional mixtures of powders.

The test results show, for the use of an admixture of powder of the polyacrylamide to pulverulent methyl hydroxyethylcellulose in a highly calcium-containing construction material system, a virtually complete loss of thickening action even after storage for three days. The inventive particle composition, in contrast, exhibits a retained thickening action in the gypsum filler system even after storage for ten days.

TABLE 1
Evaluation of the filler material after a stirring time of 1 min

| | | |
|---|---|---|
| Storage time Start | 3 days | 4 days |

| | Thickening | | Thickening | | Thickening | |
|---|---|---|---|---|---|---|
| | behaviour (%) | Stability (%) | behaviour (%) | Stability (%) | behaviour (%) | Stability (%) |
| Comparison | 100 | 100 | 80 | 85 | 80 | 85 |
| 1-1 | | | | | | |
| Mixture 1 | 100 | 100 | 100 | 100 | 100 | 105 |

| | 5 days | | 6 days | | 7 days | | 10 days | |
|---|---|---|---|---|---|---|---|---|
| | Thickening | | Thickening | | Thickening | | Thickening | |
| | behaviour (%) | Stability (%) | behaviour (%) | Stability (%) | behaviour (%) | Stability (%) | behaviour (%) | Stability (%) |
| Comparison | 80 | 80 | 80 | 80 | 80 | 85 | 80 | 80 |
| 1-1 | | | | | | | | |
| Mixture 1 | 100 | 105 | 100 | 105 | 100 | 105 | 100 | 105 |

TABLE 2
Evaluation of the filler material after a stirring time of 10 min

| | Storage time | | | | | | |
|---|---|---|---|---|---|---|---|
| | Start | 3 days | 4 days | 5 days | 6 days | 7 days | 10 days |
| | Stability (%) | Stability (%) | Stability (%) | Stability (%) | Stability (%) | Stability (%) | Stability (%) |
| Comparison 1-1 | 100 | 100 | 100 | 90 | 85 | 85 | 80 |
| Mixture 1 | 100 | 105 | 105 | 105 | 105 | 105 | 105 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Particle compositions comprising particles of polysaccharides and/or polysaccharide derivatives and at least one synthetic polymer and optionally other additives, characterized in that
I. the particles contain a plurality of solid phases, wherein
II. the solid phase of the synthetic polymer being contained in the solid phase of the polysaccharide and/or polysaccharide derivative.

2. Particle composition according to claim 1, characterized in that the polysaccharide derivative is a cellulose ether.

3. Particle composition according to claim 1, characterized in that the synthetic polymer is a polyacrylamide or polyacrylamide derivative.

4. Particle composition according to claim 1, characterized in that the synthetic polymer is present in amounts of 0.01-25% by weight, based on the polysaccharide or polysaccharide derivative in a dry form.

5. Process for producing particle compositions of polysaccharides and/or polysaccharide derivatives and at least one synthetic polymer and also, and optionally, other additives, comprising
A) adding to a water-moist polysaccharide and/or polysaccharide derivative having a water content of 30-80% by weight, one or more synthetic polymers in non-dissolved form in a total amount of 0.01-25% by weight, based on the polysaccharide or polysaccharide derivative in a dried form, and
B) processing the resulting admixture to a mass in a homogenizer, and optionally adding water in this process stage, and
C) grinding and drying, or drying and grinding, or mill drying the resultant mass.

6. Process according to claim 5, characterized in that further aids are added in amounts of <50% by weight before, during or after the processing in the homogenizer.

7. Process according claim 5, characterized in that cellulose ethers, preferably those having a thermal flock point in water, are used as polysaccharide derivatives.

8. Process according to claim 5, characterized in that the water content of the cellulose ether is 50-80% by weight.

9. Process-according to claim 5, characterized in that polyacrylamides and polyacrylamide derivatives are used as synthetic polymers.

10. A process for preparing construction material mixtures comprising incorporating therein the compositions of claim 1.

11. The process according to claim 10, characterized in that the construction material mixtures are mortars, plasters, fillers or thin-bed adhesives.
